(19) United States
(12) Patent Application Publication
(10) Pub. No.: US 2017/0132642 A1
(43) Pub. Date: May 11, 2017

(54) SYSTEM, METHOD, AND RECORDING MEDIUM FOR YIELD MANAGEMENT OF EVENTS

(71) Applicant: International Business Machines Corporation, Armonk, NY (US)

(72) Inventors: Jakub Marecek, Dublin (IE); Robert Shorten, Mulhuddart (IE); Fabian Roger Wirth, Meath (IE); Jia Yuan Yu, Quebec (CA)

(21) Appl. No.: 14/934,468

(22) Filed: Nov. 6, 2015

(51) Int. Cl. G06Q 30/02

(52) U.S. Cl. CPC G06Q 30/0201; G06Q 30/0206; G06Q 30/0247

(57) ABSTRACT

A yield management system, method, and non-transitory recording medium for an event, including modeling demand for tickets for the event to create a demand model, analyzing data comprising recent consumer purchases of the tickets for the event and recent advertising for the same event, and adjusting decision variables, comprising advertising spending for the event, the split thereof to various media, and the price of tickets, based on the data and the demand model.

### BACKGROUND

The present invention relates generally to yield management for events, and more particularly, but not by way of limitation, to a system, a method, and a recording medium for combining revenue management with advertising management to maximize profits.

Many yield management methods for events have fixed prices until the date of the event. Other conventional yield management methods for events only deal with dynamic changing of the ticket prices. The currently proposed methods do not consider any model of the impact of advertising on ticket sales (or information on past advertising spending or details of price sensitivity of various segments of the population, the reach of various marketing channels to various segments of the population, or similar), which would make it possible to decide how to make the adjustment of both ticket prices and advertising spending jointly.

Other conventional methods have been proposed to estimate the impact of advertising on sales and marketing mix to use within the advertising budget. Such methods, however, ignore the effects of ticket prices, and are disjoint from the methods for dynamic changing of ticket prices.

However, one should like to see both the dynamic changing of the prices and dynamic changes of the spending on advertising as two out of multiple means of modulating the demand, which should be considered jointly. Yield management methods proposed so far are limited in their application in that they do not consider the effects of both pricing and spending on advertising on the demand process at the same time, with the aim of maximizing the profits. Thereby, some tickets are sold at less than achievable market value, some of the tickets may not be sold at all, and some spending on advertising may be excessive, when the event would sell out without advertising, all due to the price and advertising not considered jointly.

### SUMMARY

In view of the foregoing and other problems, disadvantages, and drawbacks of the aforementioned background art, it is desirable to provide an improved way to maximize profits by yield management revenues for sales by integrating dynamic pricing and dynamic advertising control so as to maximize profits, avoid selling tickets at less than market price, avoid empty seats by weighing if price and/or advertising is the cause of low ticket sales, and avoid excess spending on advertising when tickets would sell without the excess spending.

An exemplary aspect of the disclosed invention provides a system, method, and non-transitory recording medium for combining revenue management with management of advertising spending.

In an exemplary embodiment, the present invention can provide a yield management method for an event, including modeling demand for tickets for the event to create a demand model, analyzing data comprising recent consumer purchases of the tickets for the event and recent advertising for the same event, and adjusting decision variables, comprising advertising spending for the event, the split thereof to various media, and the price of tickets, based on the data and the demand model.

Further, in another exemplary embodiment, the present invention can provide a non-transitory computer-readable recording medium recording a yield management program for an event, the program causing a computer to perform: modeling demand for tickets for the event to create a demand model, analyzing data comprising recent consumer purchases of the tickets for the event and recent advertising for the same event, and adjusting decision variables, comprising advertising spending for the event, the split thereof to various media, and the price of tickets, based on the data and the demand model.

Even further, in another exemplary embodiment, the present invention can provide a yield management system, including a demand model device configured to model demand of tickets for the event to create a demand model, a purchase analyzer device configured to analyze consumer purchase data of the tickets for the event, an advertisement and price adjustment device configured to adjust advertising spending for the event based on the consumer purchase data and to adjust a price of the tickets based on the consumer purchase data, the price adjustment device and the advertisement adjustment device jointly perform the adjustments for the advertising spending and the price of the tickets.

There has thus been outlined, rather broadly, an embodiment of the invention in order that the detailed description thereof herein may be better understood, and in order that the present contribution to the art may be better appreciated. There are, of course, additional exemplary embodiments of the invention that will be described below and which will form the subject matter of the claims appended hereto.

It is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

The exemplary aspects of the invention will be better understood from the following detailed description of the exemplary embodiments of the invention with reference to the drawings.

FIG. 1 exemplarily shows a block diagram illustrating a configuration of a yield management system 100.

FIG. 2 exemplarily shows a high level flow chart for a simplified yield management method 200 for maximizing profit.

FIG. 3 exemplarily shows a high level flow chart for a yield management method 300 for maximizing profit.

FIG. 4 exemplarily shows a detailed flow chart for dynamically modeling historical data to be used in a yield management method 500.

FIG. 5 depicts a cloud computing node according to an embodiment of the present invention.

FIG. 6 depicts a cloud computing environment according to another embodiment of the present invention.

FIG. 7 depicts abstraction model layers according to an embodiment of the present invention.

### DETAILED DESCRIPTION

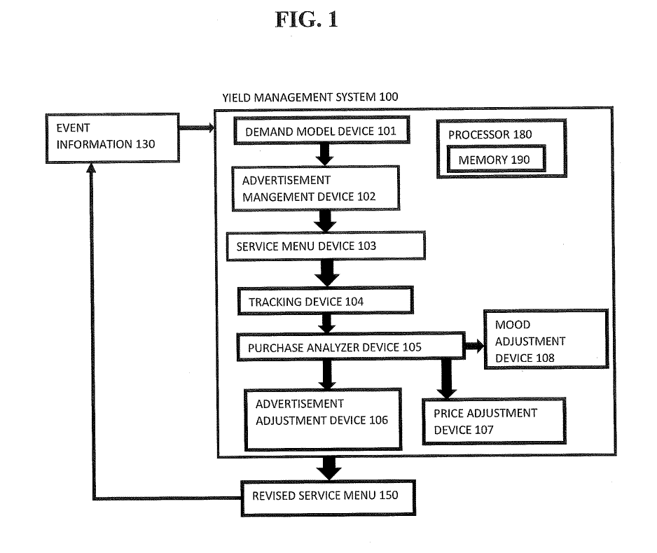

The invention will now be described with reference to FIGS. 1-7, in which like reference numerals refer to like parts throughout. It is emphasized that, according to common practice, the various features of the drawing are not necessary to scale. On the contrary, the dimensions of the various features can be arbitrarily expanded or reduced for clarity. Exemplary embodiments are provided below for illustration purposes and do not limit the claims.

It should be noted that there is a technical problem in the related art that profit is not maximized since there is excess spending on advertising and dynamic ticket price change without reason (i.e., advertisement and ticket price are not jointly monitored) and the inventors have invented a technical solution to the technical problem in the related art by dynamically and jointly monitoring the advertising and ticket prices to maximize the profit of each event.

With reference now to FIG. 1, the yield management system 100 includes a demand model device 110, an advertisement management device 102, a service menu device 103, a tracking device 104, a purchase analyzer device 105, an advertisement adjustment device 106, a price adjustment device 107, and a mood adjustment device 108. The yield management system 100 receives event information 130 as an input into the system and outputs a revised service menu 150. The yield management system 100 includes a processor 180 and a memory 190, with the memory 190 storing instructions to cause the processor 180 to execute each device of the yield management system 100.

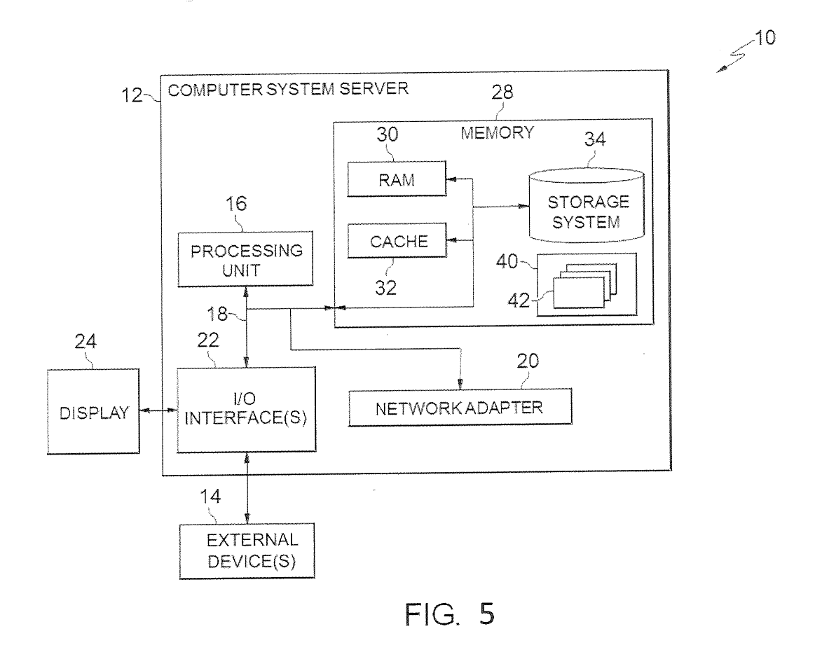

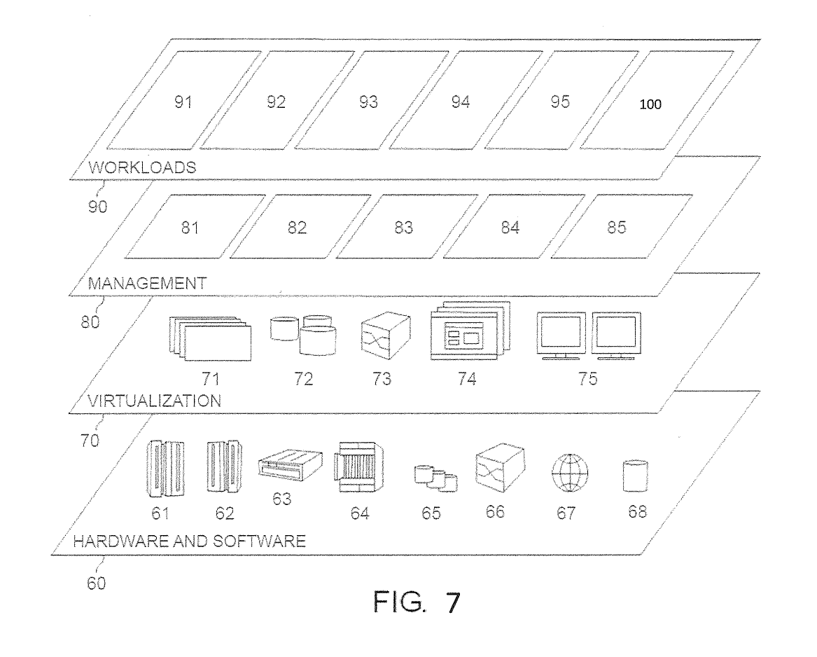

Although as shown in FIGS. 5-7 and as described later, the computer system/server 12 is exemplarily shown in cloud computing node 10 as a general-purpose computing device which may execute in a layer the yield management system 100 (FIG. 7), it is noted that the present invention can be implemented outside of the cloud environment.

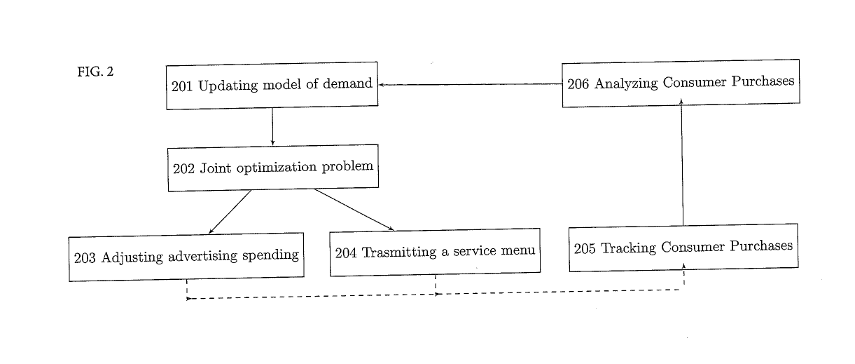

With reference now to FIG. 2, the yield management system performs a number of steps, comprising updating the model of demand 201, jointly optimizing profits over decision variables comprising decision on the spending on advertising and price 202, adjusting the spending on advertising 203 using the decisions obtained in 201, and transmitting the service menu 204 comprising the price decisions obtained in 201. In response to the advertising, both in the past and current, and the prices, both in the past and current, the customers make their purchases, which is highlighted by the dashed line. The purchases are tracked 205 and analyzed 207, in order to obtain an updated model of demand.

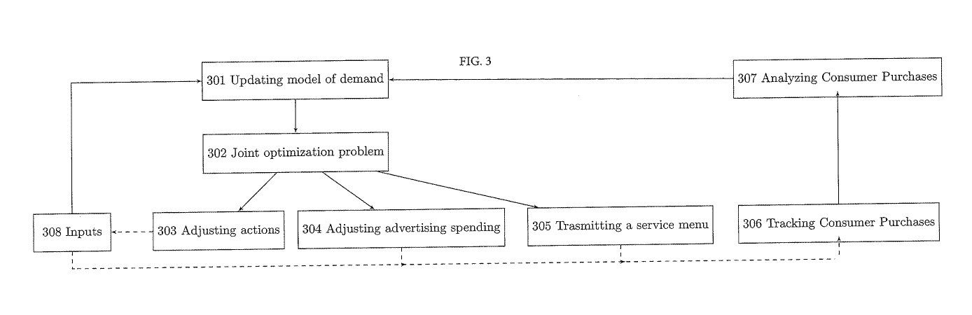

With reference now to FIG. 3, the yield management system can be extended to perform a number of further steps, comprising taking actions that indirectly influence further measurable inputs. This can take the form of spreading information unrelated to the event, but perhaps related to a particular music genre, sport, or economic developments, or of a particular tone in the news media, social media, and similar. These may have indirect impact on the purchase decisions. The impact can be estimated from historical data and considered in the model of demand. With reference now to FIG. 3, the model of demand considering those is used 301 to jointly optimize profits 302 over decision variables comprising decision on the spending on advertising, price, and actions to take to adjust the inputs. Subsequently, the following three steps can be taken in parallel: taking actions to adjust the inputs 303, adjusting the spending on advertising 304 using the decisions obtained in 302, and transmitting the service menu 305 comprising the price decisions obtained in 302. In response to the advertising, both in the past and current, and the prices, both in the past and current, and further measurable inputs 308, the customers make their purchases, which is highlighted by the dashed line. The purchases are tracked 306 and analyzed 307, in order to obtain an updated model of demand 301.

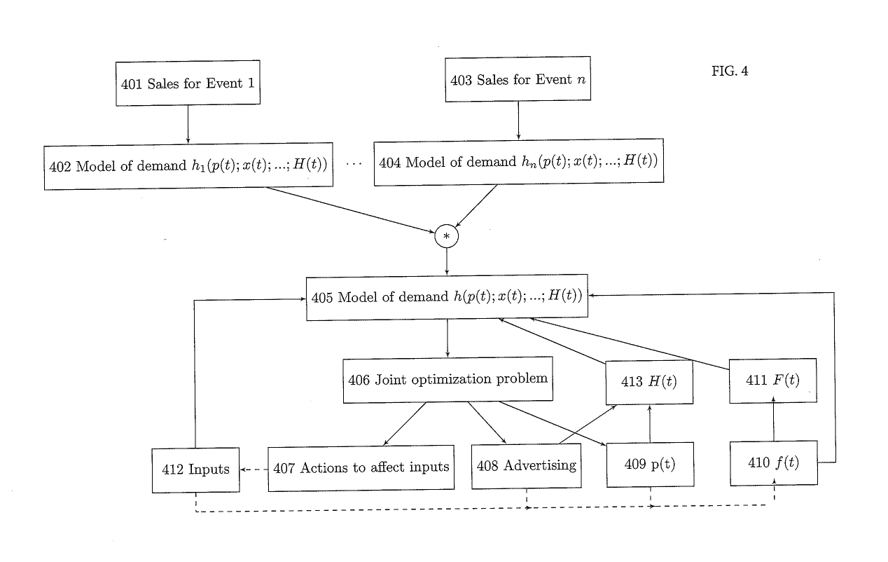

With reference to FIG. 4, the yield management system considers the historical records of previous events 1 in 401, up until previous event n in 403. Historical records of event 1 correspond to a demand model 402, while historical records of event n correspond to a demand model 404. If one sees each demand model as a conditional probability density function, one could consider performing a convolution to obtain the model of demand 405 based on all on those. Such a model of demand is parametric in the price p(t) 409 and other information H(t) provided to the customers 413 and further inputs received by the customers 412. Using the demand model 405, one can formulate an optimization problem 406, which optimizes jointly over the actions 407 to affect the inputs not influenced directly, such as the social media, the spending on advertising 408, and the price 409. Based on the price, advertising, and further inputs, customers make their purchases, as shown by the dashed line, which get tracked. The output of the tracking is the density of sales 410 and the corresponding update of the cumulative sales 411. These are fed back to update the model of demand 405.

The event information 130 includes information for each live event (i.e., sporting events, concerts, performances, etc.) that has a finite capacity partitioned into one or more service categories, and a finite period of sales, partitioned into one or more time intervals. In other words, the event information includes the capacity for the event and the time from when ticket sales are available to the time when ticket sales end, each of which are broken into particular intervals or categories to be analyzed by the yield management system 100.

The capacity service category can include, for example, a category of patrons who do not need advertising to purchase a ticket to the event, a category of patrons who need advertising at a certain level to purchase a ticket, etc.

The choice of the capacity of the event can be predetermined based on a discrete set of options.

The demand model device 101 models demand of tickets for the event to create a first demand model. The demand model device models the demand using equation (1): (f(t)/(1−F(t)))=h(p(t); x(t); . . . ; H(t)) where f(t) represents the density of sales at time t, F(t) is cumulative sales up to time t, p(t) is price at time t, x(t) is the spending on advertising at time t, H(t) is all known data up to time t comprising the history of prices and advertising spending per medium, and “ . . . ” includes further data sources such as mood among the customers and mood-altering events (i.e., the rise or drop in stock market, a natural or man-made catastrophe, a conflict, etc.), any constants the system wants to enter, proximity of event to audience, etc. The equation allows for modification by including additional variables or constants into the demand function which is possible due to the finite time interval. Historical data allow for h to be obtained using an appropriate statistical tool, such as multi-variate polynomial regression or piece-wise linear regression.

It is noted that an objective of modeling the profits, which is denoted P(t) at time t, and which is a function whose domain comprise the history of demand f, the cumulative spending on advertising so far c(H(t)), and the history of prices p. Therewith, an optimal control problem is formulated, where P(t) is maximized over the time horizon between now and the event, subject to constraints, which link current and past advertising and ticket prices H and possible further decisions with future demand f, based on the demand model h. Since there is a finite time interval between the start of ticket sales to the time of the event, and one can plausibly with to change the prices only finitely many times during that period, at pre-determined times, one can discretize the time, which simplifies computations considerably. Specifically, optimality conditions of the optimal control problem are expressible in a finite problem of mathematical optimization.

The advertisement management device 102 receives the event information and dynamically spends resources on advertising. For example, the advertisement management device 102 spends certain resources on advertising the event by targeting one or more service categories or customer group(s) in particular. At each time interval, the amount of spending can dynamically change based on future calculations to be described in detail later.

The service menu device 103 transmits a service menu to consumers, the service menu including a cost indicator for each of the service categories.

The tracking device 104 compiles and tracks all purchase data when the consumer uses the service menu device 103.

The purchase analyzer device 105 analyzes the compiled and tracked data output from the tracking device 104. The purchase analyzer device 105 analyzes the data for consumer purchase trends as a result of the advertising by the advertisement management device 102, the current price of the tickets, the mood of the public, etc.

The purchase analyzer device 105 uses equation (1) to analyze the model demand and to maximize profit.

The mood of the public can be monitored via Twitter® or other social media. For example, if there has been a devastating accident and it is heavily covered in the news, people are less likely to want to buy event tickets for enjoyment. On the contrary, if social media is showing only positive indicators, people will be more likely to want to purchase tickets.

That is, the purchase analyzer device 105 determines whether or not to adjust advertisement to incur additional ticket sales to fill capacity, to adjust the price of a ticket to incur additional ticket sales to fill capacity, or not to make any adjustments if the mood of society is the reason for the less than desirable ticket sales such that profit of the event is maximized. The purchase analyzer device 105 jointly outputs the data to the advertisement adjustment device 106, to the price adjustment device 107, and to the mood adjustment device 108.

The advertisement adjustment device 106 and the price adjustment device 107 jointly adjust either advertisement spending or ticket price based on the data of the purchase analyzer. However, if the purchase analyzer device determines that the mood is the reason for low ticket sales, the mood adjustment device 108 will send out via social media an enormous amount of mood increasing pictures related to the event. For example, the mood adjustment device can send out pictures of puppies, children playing, the details of the event combined with positive feelings such as donating to charity, military support, etc.

In this way, the advertisement adjustment device 106 and the price adjustment device 107 jointly adjust the amount of advertising and ticket price concurrently with the mood being adjusted by the mood adjustment device 108.

The price adjustment device 107 adjusting of the price of the tickets includes a restriction on a change of price by a relative amount between time interval to time interval or within a number of time intervals.

The revised service menu 150 receives the updated data from the yield management system 100 and displays the user with a revised service menu that either changed the advertisement or the price of the ticket.

New event information 130 is discovered from the revised service menu and input into the yield management system 100. In this manner, the yield management system changes the ticket prices or the advertisement spending for each time-interval since there is a finite time-interval before the event data. In other words, the event information 130 is input into the yield management system and the demand model device 101 models a second demand model based on the adjustments made by the advertisement adjustment device 106, price adjustment device 107, and mood adjustment device 108.

The yield management system 100 repeats the execution of the devices for the finite time interval (i.e., until the event begins).

Therefore, profit can be maximized by jointly monitoring the ticket price and the advertisement effects on an individual to purchase the ticket.

It should be noted that the advertisement adjustment device 106, the price adjustment device 107, and the mood adjustment device 108 target different categories of patrons in different manners. For example, there is no need to advertise to the hardcore fans (i.e., those who support the team/performance no matter what the situation) of an event or there is no need to adjust the price for the wealthy since they would go no matter the price. Since the capacity is split into categories of probable attendees, the yield management system 100 is better able to maximize profit.

Also, since the start of the ticket sales to the time of the event date is a finite time interval, an additional weighting variable can be used to increase advertising or decrease ticket sales based on the time left before the event.

FIG. 2 shows a high level flow chart for a yield management method 200 for maximizing profit. The method shown is for one exemplary time interval, but loops through for multiple time intervals as shown by steps 206b and 201 being a loop.

Step 201 models the demand using, for example, equation (1).

Step 202 spends resources on advertisement in order to increase sales of tickets.

Step 203 transmits a service menu for the user to purchase tickets.

Step 204 tracks consumer purchase data.

Step 205 analyzes the consumer purchase data tracked in step 204 using equation (1) in order to determine adjustments to the demand equation to maximize the profit.

Step 206a and step 206b adjust the advertisement spending and the price jointly based on step 205.

The adjusted prices and advertisement spending data is looped back to the initial model of demand in step 201 and the method repeats for each time interval up until the event start time.

FIG. 3 shows a high level flow chart for a yield management method 300 for maximizing profit. The method shown is for one exemplary time interval, but loops through for multiple time intervals as shown by steps 306b and 301 being a loop.

Step 301 models the demand using, for example, equation (1).

Step 302 spends resources on advertisement in order to increase sales of tickets.

Step 303 transmits a service menu for the user to purchase tickets.

Step 304 tracks consumer purchase data.

Step 305 analyzes the consumer purchase data tracked in step 304 using equation (1) in order to determine adjustments to the demand equation to maximize the profit. Step 305 takes into consideration all variables and constants that can be input into equation (1) in addition to P(t), x(t), F(t), H(t). In other words, Step 305 takes into consideration the constraints “ . . . ” which can be input by the operator.

Step 306a optimizes the inputs of equation (1) and all other variables by adjusting the advertisement spending, the price, mood, or other constants jointly based on step 305.

Step 306b influences the variables of equation (1) by, for example, flooding social media (i.e., by an external source) with positive feelings to raise buyers' mood and increase the desire to attend events.

The method loops back to step 301 and the demand model is updated for a different time interval with the optimized inputs in step 306a and the influence of the input variables in step 306b is also factored into the updated demand equation.

FIG. 4 shows a prediction algorithm for predicting the dynamic historical data in step 501a of FIG. 5.

More specifically, the algorithm of FIG. 4 samples, for each resource, the initial state distribution ρ₀(x) to estimate the previous state xₜ₋₁.

Subsequently, the loop composed of Steps 2-8 is run.

For each resource, the current state xₜ conditioned on xₜ₋₁ using conditional probability distribution p(xₜ|xₜ₋₁) is obtained.

For each resource, the delay code cᵢ conditioned on xₜ₋₁ using conditional probability distribution q(cₜ|xₜ) is obtained.

For each resource, the demand-related noise-term Y_{ai,i} conditioned on xₜ and cₜ using conditional probability distribution r(yₜ|cₜ, xₜ) are obtained.

For each time interval, the demand as a convolution of Y_{ai,i}, the demand time sⱼ, and a function of the maximum of sale times {Aⱼ} of predecessors is estimated.

For each time interval, the variables of demand as a convolution of the time interval Dᵢ, the finite time interval τᵢ, and the variable noise-term Vᵢ are estimated.

As a result, it is possible to use historical ticket sale data (i.e., sale price, advertising price, mood effects) and output a prediction of how the historical ticket sale data can affect the future demand model in order to further optimize profits.

FIG. 5 shows a high level flow chart for a yield management method 500 for maximizing profit. The method shown is for one exemplary time interval, but loops through for multiple time intervals as shown by steps 506b and 501b being a loop. It is noted that the dynamic historical data computed by the algorithm of FIG. 4 is used to further optimize the initial demand modeling.

Step 501b models the demand using, for example, equation (1) and the dynamic historical data computed by the algorithm in FIG. 4.

Step 502 spends resources on advertisement in order to increase sales of tickets.

Step 503 transmits a service menu for the user to purchase tickets.

Step 504 tracks consumer purchase data.

Step 505 analyzes the consumer purchase data tracked in step 504 using equation (1) in order to determine adjustments to the demand equation to maximize the profit. Step 505 takes into consideration all variables and constants that can be input into equation (1) in addition to P(t), x(t), F(t), H(t). In other words, Step 505 takes into consideration the “ . . . ” which can be input by the operator.

Step 506a optimizes the inputs of equation (1) and all other variables by adjusting the advertisement spending, the price, mood, or other constants jointly based on step 505.

Step 506b influences the variables of equation (1) by, for example, flooding social media with positive feelings to raise buyers' mood and increase the desire to attend events.

Exemplary Hardware Aspects, Using a Cloud Computing Environment

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

Referring now to FIG. 5, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems; server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 5, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

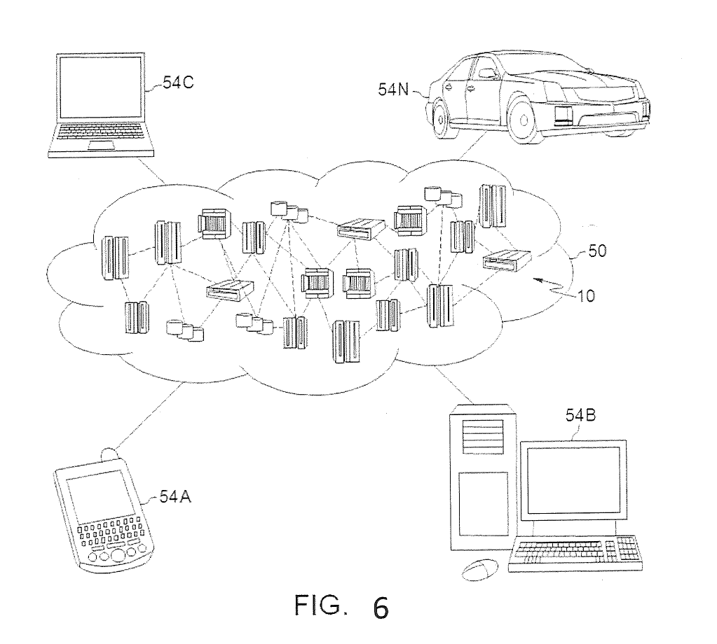

Referring now to FIG. 6, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 8 are intended to be illustrative only and that computing nodes 10 and cloud computing environment 50 can communicate with any type of computerized device over any type of network and/or network addressable connection (e.g., using a web browser).

Referring now to FIG. 7, a set of functional abstraction layers provided by cloud computing environment 50 (FIG. 6) is shown. It should be understood in advance that the components, layers, and functions shown in FIG. 7 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and, more particularly relative to the present invention, the yield management system 100 described herein.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Further, Applicant's intent is to encompass the equivalents of all claim elements, and no amendment to any claim of the present application should be construed as a disclaimer of any interest in or right to an equivalent of any element or feature of the amended claim.

What is claimed is:

1. A yield management method for an event, comprising:
modeling demand for tickets for the event to create a demand model;
analyzing data comprising recent consumer purchases of the tickets for the event and recent advertising for the same event; and
adjusting decision variables, comprising advertising spending for the event, the split thereof to various media, and the price of tickets, based on the data and the demand model.

2. The yield management method of claim 1, wherein inputs of the demand model further comprise data from an external source, and analyzing the data.

3. The yield management method of claim 2, further comprising modeling the demand based on a mood of consumers, analyzing data on the mood of consumers, and adjusting the decision variables comprising influencing the mood of potential consumers of the tickets for the event.

4. The yield management method of claim 3, wherein the adjusting of the advertising spending for the event, the adjusting of the price of the tickets, and the influencing of the mood are jointly performed.

5. The yield management method of claim 2, further comprising:
modeling the based on other events taking occurring either at a time of sale of the tickets or at a time of the event;
analyzing data on the other events; and
adjusting the decision variables based on the other events.

6. The yield management method of claim 1, wherein the modeling further includes creating the demand model based on historical data of one or more prior events.

7. The yield management method of claim 1, wherein the modeling, the analyzing, and the adjusting repeat a finite number of times for a finite time period.

8. The yield management method of claim 6, wherein the demand model is a function, the domain including a price of the ticket and an amount spent on advertising and the image including the numbers of tickets sold by the repeat of the cycle or by the time of the event, whichever comes first.

9. The yield management method of claim 1, wherein the event has a finite capacity partitioned into one or more service categories and a finite period of sales that is partitioned into one or more time intervals, wherein said demand model is updated for each time interval.

10. The yield management method of claim 9, wherein the demand model is a function, the image including the numbers of tickets sold in the next intervals, and the domain including one or more of the following:
a price of tickets in each past interval,
advertising spending in each past interval,
a split thereof to the various media in each past interval,
advertising spending planned for each future interval,
a split thereof to various media,
a mood of the consumers in each past interval, a capacity of the event,
other events,
capacities of the other events and advertising spending and a split thereof to the various media in each past interval, and
at one or more mood altering events in the past intervals or planned for the future intervals.

11. The yield management method of claim 9, further comprising:
in each time interval, spending certain resources on advertising the event which targets one or more service categories or customer group.

12. The yield management method of claim 9, further comprising:
in each time interval, transmitting a service menu to consumers, the service menu including a cost indicator and being produced for each of service categories.

13. The yield management method of claim 9, further comprising tracking the consumer purchase data for each of the service categories.

14. The yield management method of claim 9, further comprising:
in each time interval, transmitting a service menu to consumers, the service menu including a cost indicator and being produced for each of service categories; and
tracking, subsequent to the transmitting, the consumer purchase data for each of the service categories.

15. The yield management method of claim 9, wherein the adjusting of the price of the tickets includes a restriction on a change of price by a relative amount between time interval to time interval or within a number of time intervals.

16. The yield management method of claim 9, wherein a choice of the capacity of the event is predetermined based on a discrete set of options.

17. The yield management method of claim 9, wherein partitioning of the capacity of the event interval-to-interval or at pre-determined intervals is adjustable.

18. The yield management method of claim 9, wherein the adjusting of the advertising spending further allows for determining a media mix and an advertising targeting decision dependent on each service category,
wherein the adjusting the advertising spending further allows for determining a media mix and an advertising targeting decision independently of each service category, and
wherein the finite time period is from a start of ticket sale date to a date of the event.

19. A non-transitory computer-readable recording medium recording a yield management program for an event, the program causing a computer to perform:
modeling demand for tickets for the event to create a demand model;
analyzing data comprising recent consumer purchases of the tickets for the event and recent advertising for the same event; and
adjusting decision variables, comprising advertising spending for the event, the split thereof to various media, and the price of tickets, based on the data and the demand model.

20. A yield management system, comprising:
a demand model device configured to model demand of tickets for the event to create a demand model;
a purchase analyzer device configured to analyze consumer purchase data of the tickets for the event;
an advertisement and price adjustment device configured to adjust advertising spending for the event based on the consumer purchase data and to adjust a price of the tickets based on the consumer purchase data,
wherein the price adjustment device and the advertisement adjustment device jointly perform the adjustments for the advertising spending and the price of the tickets.
